(19) United States
(12) Patent Application Publication
(10) Pub. No.: US 2007/0183144 A1
(43) Pub. Date: Aug. 9, 2007

(54) Illumination device

(76) Inventors: Kurt Van Ulmer, Denver, CO (US); Justin Discoe, Windsor, CO (US); Cheryl Stoughton Goff, Denver, CO (US); Tyler Cornaby, Gastonia, NC (US)

Correspondence Address: MARTIN & HENSON, P.C., 9250 W 5TH AVENUE, SUITE 200, LAKEWOOD, CO, 80226, US

(21) Appl. No.: 11/582,516

(22) Filed: Oct. 16, 2006

Related U.S. Application Data
(60) Provisional application No. 60/726,764, filed on Oct. 14, 2005.

(51) Int. Cl. F21V 33/00

(52) U.S. Cl. 362/184; 362/190; 362/647

(57) ABSTRACT

An illumination device for illuminating a surrounding region that is adapted to be placed on a soft penetrable support surface, such as the bottom of a pumpkin. The illumination device includes a housing with a base, which sets on the support surface and supports a power source. The base also includes a pair of prong-like electrical contacts, which penetrate the support surface. The illumination device further includes a light source in electrical communication with the power source, such that when electrical current flows between the electrical contacts the light source is operative to produce light.

### FIELD OF INVENTION

The present invention generally relates to illumination devices that produce special lighting effects. More particularly, the present invention is directed to illumination devices adapted for use to internally illuminate decorative objects related to specific holiday, seasonal, festive, or celebratory events, for example, a device to illuminate the interior of a carved pumpkin or jack o' lantern at Halloween.

### BACKGROUND OF THE INVENTION

It is a common desire among many people to be able to decorate their house for a particular seasonal, holiday, festive or other celebratory event in attempting to achieve a maximum visual impact with a minimum burden of cost and effort. In particular, the holiday of Halloween has become very popular world wide in recent years. Halloween decorations with a variety of visual effects are one of this holiday's major attributes. In accomplishing these visual effects, many things are done, such as placing carved pumpkins, or jack o' lanterns, hanging Halloween figurines, ghosts, goblins, witches, monsters, posters, shades, etc. in windows. Other visual effects include spraying a spider web material on the inside of the window, or creating a three dimensional scene in the room that is inside of the window.

Usually included, in such decorations is some sort of special lighting or illumination effect as the impact of the visual image is especially predominant at nighttime. Many ways are used to provide unique lighting such as a candle or light inside the carved pumpkin, spot or colored lights in windows, special candle enclosures along sidewalks, window ledges, etc. Candles give an especially desirable effect with their warm orange glow, and flickering light that adds to the mysterious allure of the illuminated carved pumpkin at night. However, candles have a number of drawbacks concerning mounting stability, wind extinguishments, short burn time, fumes, and fire safety.

Typically short slender candles or votive candles are used and are usually just placed in the bottom of the pumpkin without being secured in any manner to the pumpkin shell. Sometimes aluminum foil or aluminum pie pans or pins are used to set the candle in or placing the candle in a puddle of softened wax can be used also. None of the methods hold the candle securely, allowing the candle to tip over and be extinguished, or fall out of the pumpkin. Also, none of these methods contain the wax of the votive candle; therefore the burning time of the votive candle is reduced. As the candle burns in the pumpkin it is necessary to provide a chimney or flue so that smoke and heat can escape from the pumpkin interior. This flue or chimney must be carved in the top of the pumpkin shell and besides being unsightly, the presence of the pumpkin stem and correspondingly thick shell rind near the stem area makes adding the flue or chimney difficult. In addition, if the flue or chimney is too small or non existent an offensive odor can result from the burnt flesh of the pumpkin.

The industry has responded in addressing some of these problems associated with candles by providing better candle mounts in the pumpkin in the form of a wire holder. This holder has a first segment that wraps around the candle outside diameter with remainder of the wire inserted into the pumpkin shell. This helps overcome the problem of candle stability, but does not address the other drawbacks of candles, namely, wind extinguishments, short burn time, fumes, and fire safety.

The industry has also developed a number of battery-powered lights that attempt to mimic the effect of a candle burning inside of a carved pumpkin. The most basic battery powered light is nothing more than a small flashlight that is placed vertically in the bottom of the pumpkin with the clear lens light bulb exposed, wherein the light bulb illuminates steadily. Other devices are somewhat more advanced with the light bulb having a flat reflector to broaden the light diffusion. Also, circuitry has been added to make the light bulb flashing, which can more closely simulate a candle flickering.

One particular scenario is to use one light bulb and have a sequence of different time periods for the light to be illuminated, such as two short light illumination periods followed by a longer duration light illumination period to more closely simulate the effect of a candle flickering. Another method of accomplishing the candle flickering effect is to use a plurality of lights, wherein each light flashes independently at different times giving the image of different light illumination periods. Other devices combine continuous or flashing battery powered lights light with audible sounds that reflect the holiday or festive event, such as laughing monsters for Halloween. Finally, a plurality of lights can be of different colors to produce a softer light than using a clear lens light bulb, with the clear lens producing a bright light compared to the soft glow of a burning candle.

Despite these past developments, there remains a need in the industry for an effective device to illuminate carved fruits, such as pumpkins, gourds, squash, watermelons and the like that is inexpensive. There is a further need for such an illumination device that is easy to use. There is also a need for such a device that enhances safety. The device should also be self-contained and not require any additional items or parts to use. The present invention satisfies these desires while providing the desired source of light.

### OBJECTS OF THE INVENTION

It is an object of the present invention to provide a new and useful illumination device that may be used to create a decorative effect.

It is an aspect of the exemplary embodiments of the present invention to provide an illumination device particularly for use with carved fruit items such as pumpkins, watermelons, gourds and squashes.

Still another aspect of the exemplary embodiments of the present invention is to provide an illumination device that uses the conductivity of the shell of a carved fruit to complete an electric circuit thereby to activate the illumination device.

According to the present invention, then, an illumination device is provided. According to the exemplary embodiments of the present invention, this illumination device is adapted to be placed on a soft, penetrable support surface for illuminating a surrounding region. For example, the illumination device may be used to illuminate the interior of a carved out fruit or vegetable such as a pumpkin, watermelon, squash and the like.

Accordingly, the exemplary embodiments described herein broadly include a housing that has a base adapted to confront the support surface and that is adapted to support a power source. First and second electrical contacts are in electrical communication with the power source when the power source is supported by the housing. These first and second electrical contacts project away from the base on a first side thereof and are adapted to penetrate the support surface when the base is placed in confronting relation thereto. A light source is then supported relative to the base on a second side thereof opposite the first side. The light source is in electrical communication with the power source such that, when electrical current flows between the first and second contacts, the light source is operative to produce light.

In at least one exemplary embodiment, the housing includes a base and an upstanding sidewall forming a housing interior with this housing being adapted to support at least one battery in a received state. A top cover then encloses the interior opposite the base. This top cover is formed of a light transmissive material so that light from the light source may pass therethrough. To this end, also, the top cover may be provided with a refractive lens structure to help disperse the light. If desired, the housing may be generally cylindrical in configuration but has a flattened or squat profile so as to have good stability. The base may have legs to protect the protruding electrical contacts when the illumination device is placed on a hard surface.

The light source may be in the form of any suitable light emitting elements, such as light emitting diodes. Here, the light emitting diodes may be mounted on a printed circuit board that may be supported on stanchions in a central region of the housing interior the electrical contacts are then supported by the printed circuit board so as to protrude through openings in the base of the housing.

A reflective dish may be used in conjunction with the light source with this reflector dish operative to spread light emitting from the light source. Here, the reflector dish may be concave having a central opening through which the light source is oriented. The reflector dish may be mounted to the top cover and may also help sandwich the printed circuit board between the reflector dish and the stanchions.

In at least one exemplary embodiment, the power sources in the form of batteries that are received in the base of the housing by arcuate walls so as to be accessible exteriorly of the housing. Batteries may be inserted into these bays and latched access doors are provided to enclose the bays and the batteries therein.

In at least one exemplary embodiment, the housing for the illumination device is formed by two sections which are relatively moveable between first and second positions wherein the electrical contacts may be withdrawn toward the interior of the housing or projected so as to penetrate the conductive shell, for example, of a pumpkin.

These and other aspects of the of the exemplary embodiments of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a perspective view of a first exemplary embodiment of an illumination device according to the present invention;

FIG. 2 is a side view in elevation of the illumination device of FIG. 1 shown in position on a surface and in an inactive state;

FIG. 3 is a side view in elevation of the illumination device of FIG. 1, similar to FIG. 2, but showing the illumination device in an active state;

FIG. 4 is a perspective view of the support base for the illumination device of FIGS. 1-3;

FIG. 5 is a cross-sectional view taken about lines 5-5 of FIG. 4;

FIG. 6 is a perspective view, looking from the underside, of the light housing of the illumination device of FIGS. 1-3;

FIG. 7 is a cross-sectional view taken about lines 7-7 of FIG. 6, but in an upright orientation;

FIG. 8 is a side view in elevation of a cover plate used to enclose the light housing of FIGS. 6 and 7;

FIG. 9 is a top plan view of the cover plate of FIG. 8;

FIG. 10 is a cross-sectional view taken about lines 10-10 of FIG. 9;

FIG. 11 is a side view in elevation of the component board and the electrical components used with the illumination device of FIGS. 1-3;

FIG. 12 is a bottom plan view of the component board of FIG. 11;

FIGS. 13(a) and 13(b) are side views, in partial cross-section, showing the illumination device of FIGS. 1-3 respectively in an inactive state (FIG. 13(a)) and in an active state (FIG. 13(b));

FIG. 14 is a perspective view of an illumination device according to a second exemplary embodiment of the present invention;

FIG. 15 is a side view in elevation of the illumination device of FIG. 14;

FIG. 16 is a top plan view of the illumination device of FIGS. 14 and 15;

FIG. 17 is a bottom plan view of the illumination device of FIGS. 14-16;

FIG. 18 is an exploded side view in cross-section of the illumination device of FIGS. 14-17;

FIG. 19 is a side view in cross-section of the illumination device of FIGS. 14-17, shown in an assembled state; and

FIG. 20 is a side view in cross-section of an alternative top cover for use with the housing of the second exemplary embodiment.

### DETAILED DESCRIPTION OF THE EXEMPLARY EMBODIMENTS

The present invention broadly concerns an illumination device that can be used for decorative purposes. More specifically, the exemplary embodiments described herein can be employed to illluminate the interior of a decorative item such as a decoratively carved pumpkin, watermelon or the like. One feature of these exemplary embodiments is the provision of contact prongs which pierce the support surface thereby to establish electrical contact via the moisture in the support item and complete the electrical circuit for the electrical components.

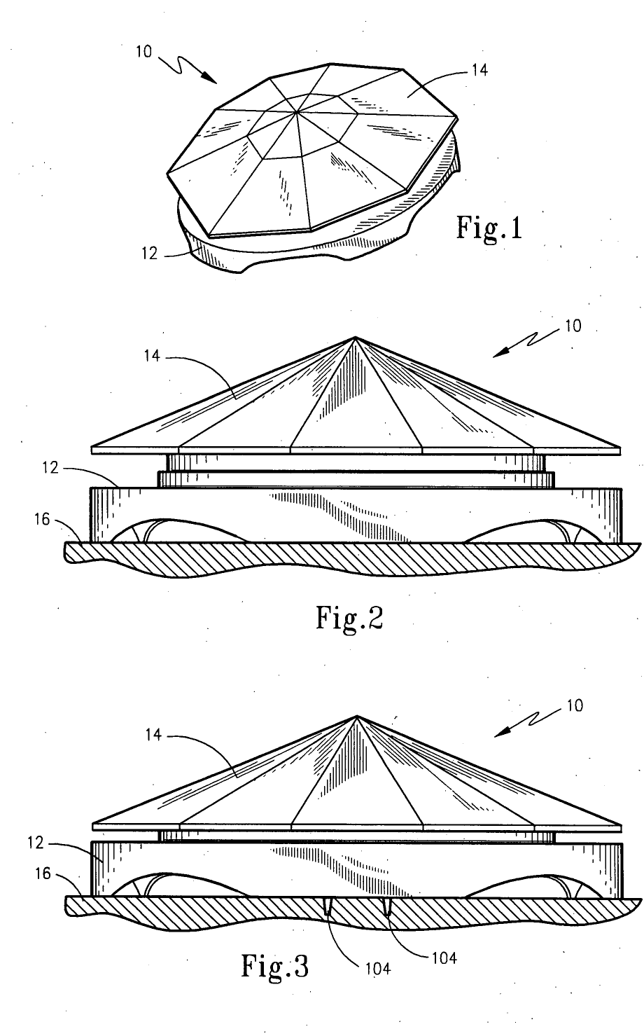

According to a first exemplary embodiment, the illumination device broadly includes a support base for positioning on a surface of an item, such as the bottom fleshy wall of a hollowed out pumpkin, a light housing that mounts to and moves relatively to the support base between an inactive state and an active state, and a cover plate that encloses the interior of the light housing and supports the electrical components therefor. The illumination device according to this exemplary embodiment of the present invention is introduced in FIGS. 1-3. Here it may be seen that illumination device 10 includes a support base 12 that supports a light housing 14. For example, as shown in FIGS. 2 and 3, illumination device 10 is operative to set on the surface of the bottom wall 16 of a carved item, such as a pumpkin, watermelon or the like. Moreover, as is shown in these two figures, light housing 14 is moveable between first and second positions relative to support base 12. In the first position, shown in FIG. 2, the illumination device is in an inactive state meaning that the lights, described below, are in an “off” state. In a second position, illustrated in FIG. 3, prongs 104 penetrate wall 16 and, due to the electrical conductivity of such wall, this penetration and conductivity serve to complete the electrical circuit thereby turning the illuminating lights into an active or “on” state. Thus, it should be understood that the present device is intended to work with a soft material into which prongs 104 may penetrate with such material having sufficient moisture so that it is electrically conductive.

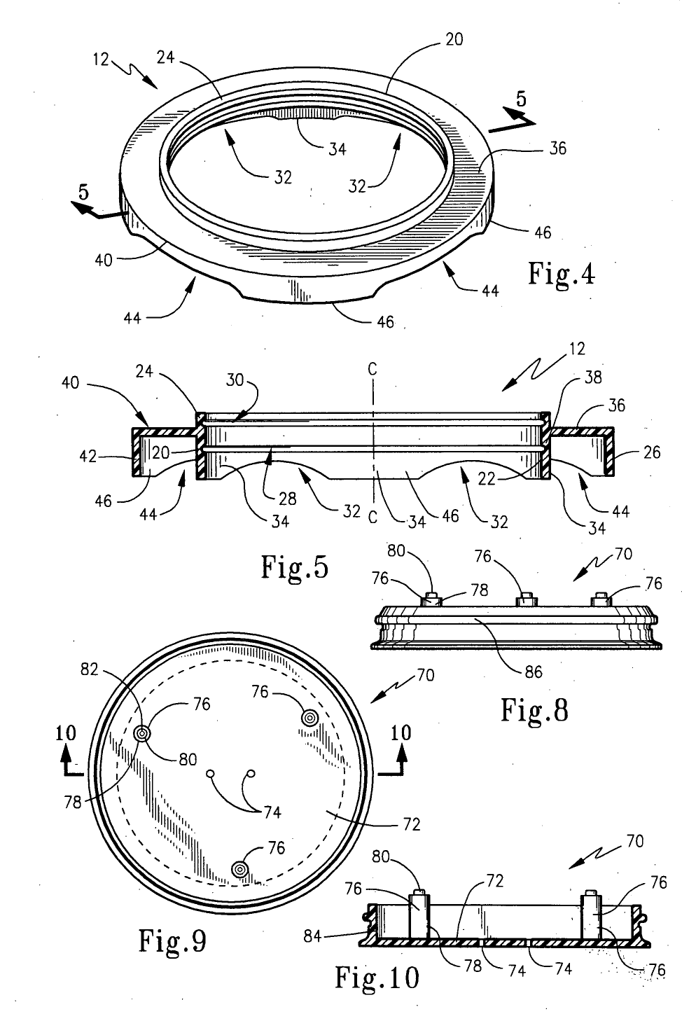

The structure of support base 12 may be understood in greater detail with reference to FIGS. 4 and 5. Here, support base 12 includes an inner annular wall 20 having a lower section 22 and an upper section 24. The inner surface 26 of inner annular wall 20 is provided with a pair of grooves, a first or lower groove 28 extending around lower section 22 and a second or upper groove 30 extending around upper section 24 with grooves 28 and 30 being parallel to one another. Lower section 22 includes a plurality of cut outs 32 to separate lower section 22 into a plurality of inner feet 34. An annular flange 36 has an inner edge 38 connected a central portion of inner wall 20 and projects radially outwardly therefrom to an outer edge 40. An outer annular wall 42 depends downwardly from flange 36 at outer edge 40 with annular wall 42 being circular and concentric with inner wall 20. Moreover, outer wall 42 has a longitudinal length, in a direction parallel to central longitudinal axis “C” that is equal to the longitudinal length of lower section 22 of inner wall 20. Outer wall 42 includes a plurality of cutouts 44 which separate outer wall 42 into a plurality of outer feet 46. Thus, outer feet 46 and inner feet 34 terminate at a common plane “P” transverse to axis “C” .

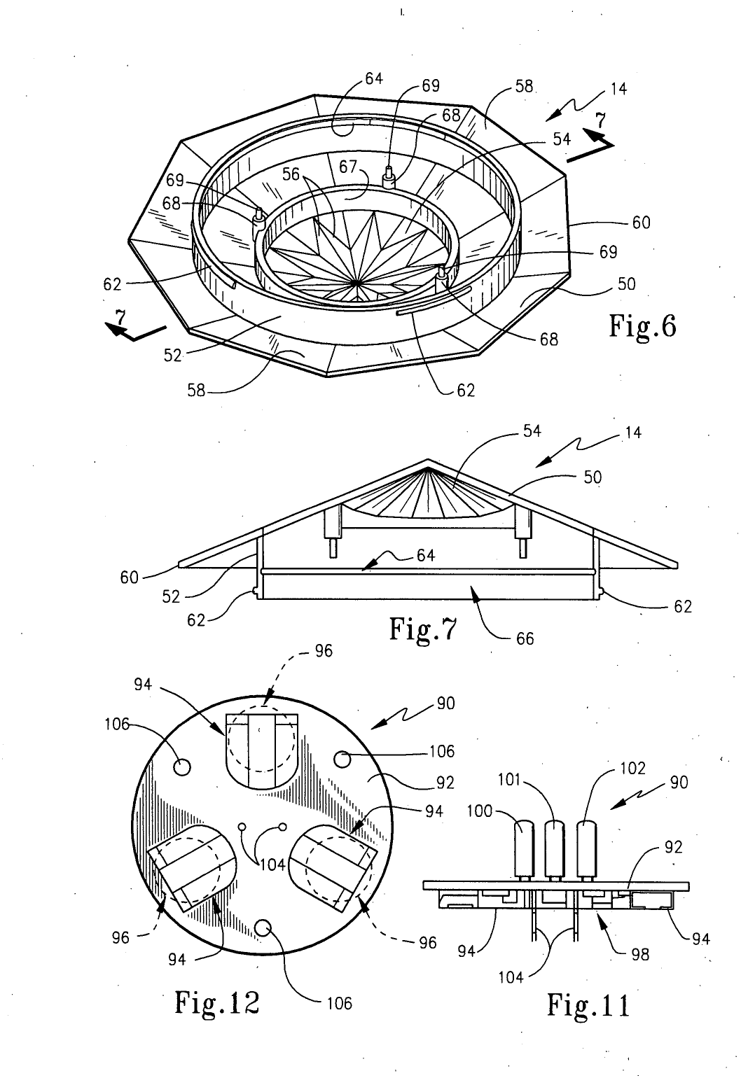

Support base 12 is adapted to mateably and telescopically engage light housing 14. Light housing 14 is best illustrated in FIGS. 6 and 7 where it may be seen that light housing 14 includes a pyramidal shaped top panel 50 from which downwardly depends a cylindrical sidewall 52. Top panel 50 includes a central window 54 that includes facets 56 so as to refract light transmitted therethrough. Window 54 may be formed of transparent or translucent plastic, for example. Panels 58 extend outwardly to terminate in a polygonal peripheral edge 60.

Downwardly depending sidewall 52 has a diameter that is just slightly less than the inside diameter of inner wall 20 so that it will telescope therein in close-fitted engagement. Sidewall 52 includes a plurality of outwardly projecting ribs 62 which engage, respectively, upper groove 40 when illumination device 10 is in the inactive state and lower groove 28 when illumination device 10 is in the active state. An inner surface of sidewall 52 includes a circular groove 64 for mounting a cover plate 70 therein.

Cover plate 70 is illustrated in FIGS. 8-10 and includes a base panel 72 having a pair of holes 74 formed at a central region thereof to accommodate prongs 104. Equiangularly spaced standoffs 76 project upwardly from base panel 72, and any convenient number of standoffs 76 may be employed. Here, two such standoffs 76 are illustrated. Each standoff 76 includes an axial bore 82 extending along the central longitudinal axis thereof. A peripheral wall 84 projects upwardly from base panel 72 on the same side thereof of standoff 76. Base wall 84 is sized for close-fitted, mated telescopic engagement with the inner surface of sidewall 52 of light housing 14. A circular ridge 86 is disposed on the outer surface of wall 84 and is positioned to engage groove 64 on the interior surface of sidewall 52. In such manner, cover plate 70 may be removeably mounted to enclose interior 66 of light housing 14 (FIG. 7).

Interior 66 of light housing 14 is provided to house a light assembly 90 that includes a plurality of lights, electronic circuitry therefore, and a battery power source therefore. Light assembly 90 is illustrated in FIGS. 11 and 12 and includes a disk shaped circuit board 92 having three battery clips 94 mounted on a first surface therefore. The battery clips 94 are adapted to receive batteries 96 and to make electrical contact therewith. Various electronic components 98 are also located on the side of circuit board 92 as battery clips 94. On the opposite side of board 92 are mounted three lights 100, 101 and 102 which are electrically connected to electronic circuitry on the opposite side thereof. Prongs 104 project perpendicular to the central axis of circuit board 92 on a side thereof opposite lights 100-102. Circuit board 92 also includes two openings 106 that are equiangularly spaced and located proximate to the outer edge of circuit board 92.

Light assembly 90 is sized and adapted for mounting in interior 66 of light housing 14. To this end, light housing 14 includes a pair of equiangularly spaced bosses 68 having longitudinal projecting fingers 69 extending therefrom. Circuit board 92 is positioned on bosses 68 with holes 106 positioned over fingers 69. A circular positioning ring 67 extends downwardly from the underside of top panel 50 of Cover plate 70 is positioned so that standoffs 76 register with bosses 68 with circuit board 92 trapped therebetween. Fingers 69 then mateably engaging each bore 82 when cover plate 70 is mounted onto light housing 14. Positioning ring 67 abuts circuit board 92 at a peripheral margin thereof. When fully inserted, ridge 86 engages groove 64 to secure cover panel 70 in place. Prongs 104 then extend outwardly of light housing 14 through holes 74 and base panel 12 of cover plate 70.

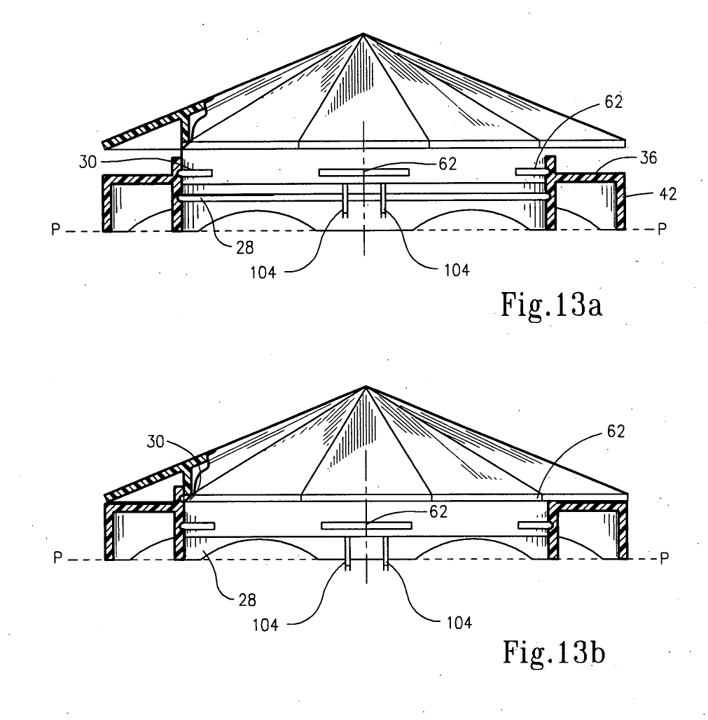

With reference now to FIGS. 13(a) and 13(b) as well as with reference again to FIGS. 2 and 3, the mounting of light housing 14 to support base 12 may now be appreciated with more specificity. When in an inactive position, ribs 62 engage upper groove 30, as is shown in FIG. 13(a). In this position, the ends of prongs 104 are above the base plane “P” defined by the ends of inner feet 34 and outer feet 46 of support base 12. A user may depress to collapse light housing 14 and support base 12 into the active position wherein ribs 62 engage lower groove 28. In this position, as is shown in FIG. 13(b), the ends of prongs 104 extend beyond plane “P” to penetrate the support surface 16. The conductivity of support surface 16 acts to complete the electric circuit 90 and thus acts as on on/off switch for the light assembly 90.

The electronic circuitry for light assembly 90 can be of any desired type well known in the art. Such light assembly may be electrically configured for constantly illuminating lights 100-102 or may be electrically configured to pulse lights 100-102 or to light these lights sequentially. In the exemplary embodiment of the present invention, for example, light assembly 90 is electrically configured to sequentially lights 100-102 sequentially for five seconds each. A small interval of overlap may be used, if desired. Lights 100-102 are, respectively, red, green, and blue LEDs so that illumination device 10 will give a multi-colored effect. Naturally, the timing, sequence, color and other parameters associated with lighting assembly 90 may be selectively done by the ordinarily skilled person depending upon design desires.

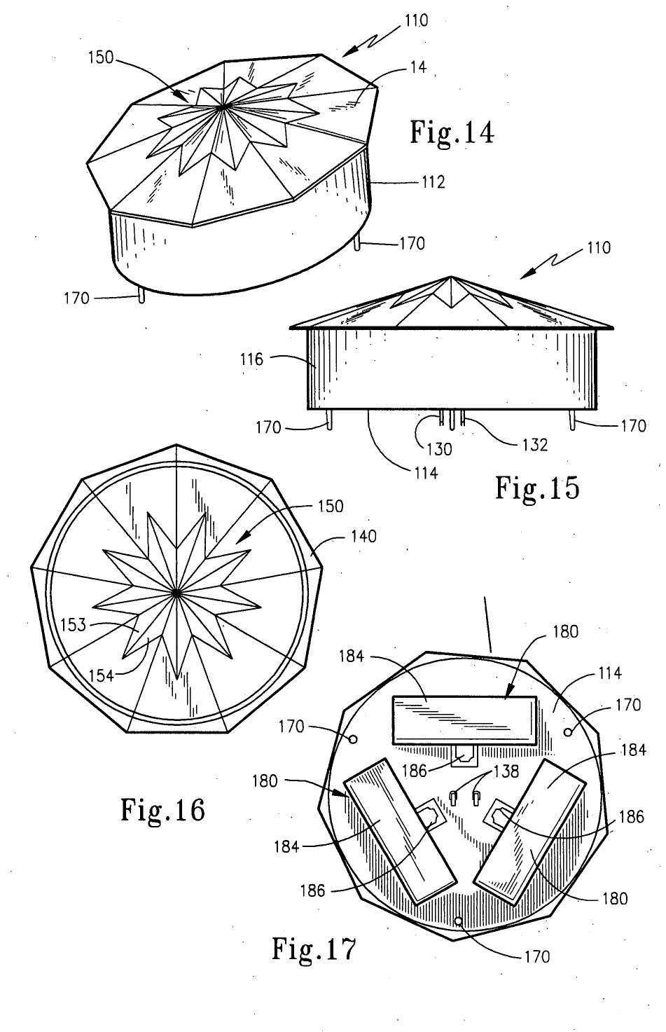

The second exemplary embodiment of the present invention is illustrated in FIGS. 14-19 where it may be seen that illumination device 110 includes a housing 112 formed by a generally circular base 114 and an upstanding cylindrical sidewall 116 that terminates in an upper rim 118. Accordingly, housing 112 has an interior 120. While housing 112 is described as having this cylindrical configuration, it should be understood that any other suitable configurations are possible. It is desirable, however, that housing 112 have a “squat” shape such that it has a width dimension that is greater than its height dimension, thus providing stability against tipping.

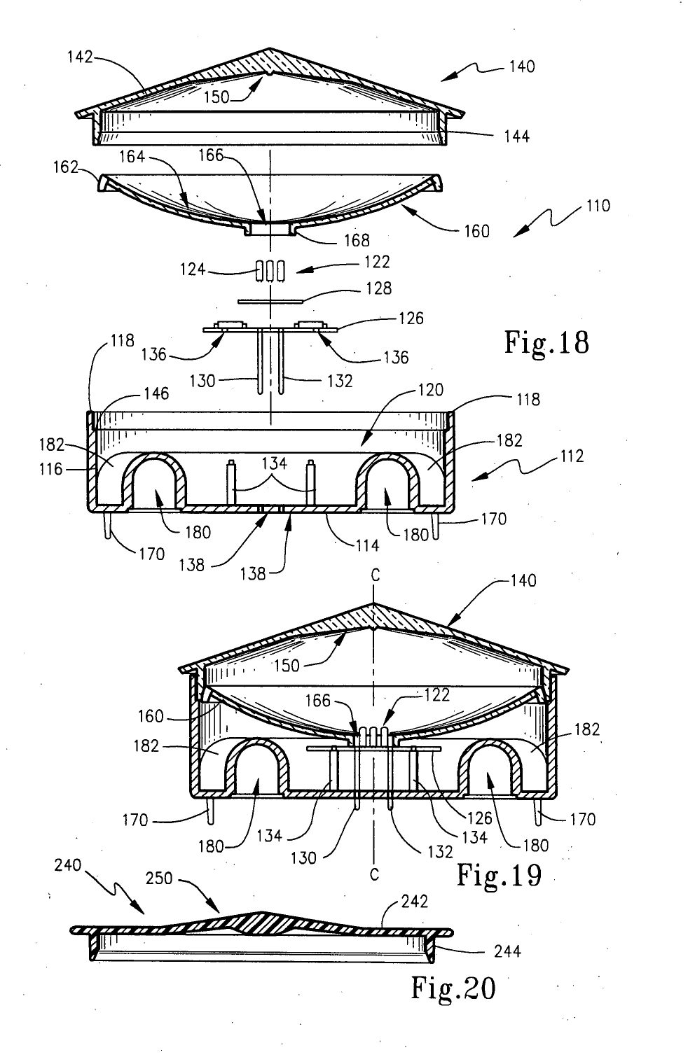

A light source 122 is disposed in the interior 120 on the interior side of base 114. Light source 122, as is seen in FIGS. 18 and 19, may include a plurality of light emitting elements such as light emitting diodes 124. These light-emitting elements may be of the same type, for example, to emit white light, but may optionally be light-emitting elements which emit differently colored light, as described above. In any event, the light emitting elements 124 are mounted on a printed circuit board 126 that supports the remaining components of the electrical circuitry such as that described above. Printed circuit board 126 includes first and second electrical conduct 130 and 132. An optional reflective film 128 may be provided, if desired, to increase reflection of light from printed circuit board 126.

In any event, printed circuit board 126, and thus light source 122, is supported relative to base 114 interiorly of housing 112. To this end, base 114 supports a pair of upright stanchions 134 which project in the interior of housing 112 in generally parallel, spaced apart relation. As may be seen in FIGS. 18 and 19, printed circuit board 126 includes openings 136 to receive the upper end pegs of stanchions 134. Accordingly, light source 122 is located approximately in the middle of the interior region of housing 112 along the central axis “C” thereof. It may be noted, also, that base 114 includes a pair of openings 138 which are oriented so that, when printed circuit board 126 is supported on stanchions 134, the prong like first and second electrical contacts 130 and 132 protrude exteriorly of housing 112 through base 114.

A top cover 140 is provided to enclose interior 120 of housing 112, with top cover 140 being at best illustrated in FIGS. 18 and 19. Here, it may be seen that top cover 140 is in the shape of a conic shell 142 from which a cylindrical wall 144 downwardly depends. Cylindrical wall 140 has a diameter so as to be press fit into housing 112 for frictional mounting. To this end, sidewall 116 of housing 112 is provided with a shoulder 146 adjacent to rim 118 so as to mate with wall 144.

Top cover 140 is formed of a light transmissive material, that is, a material that is not opaque, so that light may pass through top cover 140 to light a region surrounding illumination device 110. Here, any suitable plastic may be selected which has such light transmissive qualities. A refractive lens structure 150 is provided centrally of conic shell 142 and operates to disperse light, by refraction, that is emitted by light source 122 and received by the lens. Lens structure 150 is formed as a plurality of angled facets 152 and 154 (FIG. 16) configured in a star shaped pattern.

Returning to FIGS. 18 and 19, it may be seen that a light reflector dish 160 is provided and may be mounted to top cover 140. To this end, reflector dish 160 has a circular edge 162 mounted for press fit frictional engagement within wall 144, as is shown in FIG. 19. Reflector dish 160 has a reflective concave surface 164 that is highly reflective. Moreover, a central opening 166 is formed in reflector dish 160 along with a downwardly projecting standoff 168 around the perimeter thereof. With reference to FIG. 19, it may be appreciated that, when assembled, the stand off 168 presses against the central region of printed circuit board 126 so as to formally mount printed circuit board 126 against stanchions 134.

Moreover, when assembled, light source 122 projects through opening 166 so that light emitted thereby will be reflected by a mirrored surface of reflector dish 160 and refracted by refracted lens structure 150. Here, it may be appreciated that reflector dish 160 has a radius of curvature such that light emitting from light source 112 is dispersed as opposed to being focused to a point. That is, it has a radius of curvature so as to spread light emitting from the light source.

With reference now to FIG. 15 and 19, it may be seen that, when illumination device 110 is assembled foam like electrical contacts 130 and 132 protrude exteriorly of housing 112. In order to protect these electrical contacts should the illumination device 110 be situated on a hard surface, housing 112 includes a plurality of posts or legs 170 which project away from base 114 for a distance that is greater than the distance of electrical contacts 130 and 132.

It is again contemplated that illumination device 110 be powered by one or more batteries. In the exemplary embodiment shown in FIGS. 14-19, three battery compartments are therefore provided. With reference to FIGS. 17-19, it may be seen that three battery compartments or bays 180 are formed in base 114 by arcuate walls 182. Bays 180 may be enclosed for removable access panels or doors 184 that are provided with latches 186. When batteries are inserted into bays 180, it should be understood that suitable electrical contacts are provided so that the power source is in electrical communication with light source 120 and its associated circuit components. Thus, when electrical current is permitted to flow between first and second electrical contacts 130 and 132, the light source is operative to produce light.

It should thus be appreciated that electrical contacts 130 and 132 provide a switch arrangement for light source 132. This electrical switch arrangement, if desired, could include the conventional interrupt switch connected alternatively in series or parallel with electrical contacts 130 and 132, although the construction of such electrical contacts is deemed to be within the skill of the ordinarily skilled person in this field. However, electrical contacts 130 and 132 are provided so that, in use, base 114 can be placed in confronting relation with a support surface such that the prong like first and second electrical contacts 130 and 132 act to penetrate the support surface. Where such support surface is electrically conductive, this penetration completes the electrical circuit so that light source 122 becomes active. As noted, conventional interrupt switches may also be provided. Here, should the conventional switch be placed in series with electrical contacts 130 and 132, the light source may be deactivated without removing the contacts from penetration of the surface. Where such conventional interrupt switch is connected and parallel, the illumination device may be placed in an active state without penetrating a conductive surface with the electrical contacts.

Finally, FIG. 20 illustrates an alternative top cover for the housing 112 described above. Here, top cover 240 is constructed substantially the same as top cover 140 except that conic shell 142 is replaced with a substantially flat transparent panel 142. Again, however, a refractive lens structure 250, similar to refractive lens structure 150, is provided centrally of top cover 240.

Accordingly, the present invention has been described with some degree of particularity directed to the exemplary embodiment of the present invention. It should be appreciated, though, that modifications or changes may be made to the exemplary embodiment of the present invention without departing from the inventive concepts contained herein.

We claim:

1. An illumination device adapted to be placed on a soft, penetrable support surface for illuminating a surrounding region, comprising:
(A) a housing having a base adapted to confront the support surface and adapted to support a power source;
(B) prong-like first and second electrical contacts in electrical communication with said power source when the power source is supported by said housing, said first and second electrical contacts projecting away from said base on a first side thereof and adapted to penetrate the support surface when said base is placed in confronting relation thereto;
(C) a light source supported relatively to said base on a second side thereof opposite said first side and in electrical communication with the power source such that, when electrical current flows between said first and second contacts, said light source is operative to produce light.

2. An illumination device according to claim 1 including a refractive lens associated with said light source and operative to disperse light emitted by said light source and received by said lens.

3. An illumination device according to claim 2 wherein said refractive lens includes a plurality of facets configured in a star-shaped pattern.

4. An illumination device according to claim 1 wherein said housing includes an upstanding surrounding side wall on the second side of said base, said side wall terminating in an upper rim and forming a housing interior with said base.

5. An illumination device according to claim 1 including a top cover disposed in generally parallel relation to said base and supported by said rim, said top cover operative to enclose the interior of said housing.

6. An illumination device according to claim 4 wherein said light source is mounted on a printed circuit board.

7. An illumination device according to claim 6 wherein said base includes at least one upright stauchion, said printed circuit board being supported on said stanchion.

8. An illumination device according to claim 1 including a reflector dish associated with said light source.

9. An illumination device according to claim 1 wherein said power source includes at least one battery, said base including at least one bay adapted to receive said battery.

10. An illumination device according to claim 1 wherein said base includes a plurality of legs on the first side thereof, said legs projecting away from said base a distance greater than said electrical contacts.

11. An illumination device adapted to be placed on a soft, penetrable support surface for illuminating a surrounding region, comprising:
(A) a housing including a base and an upstanding side wall forming a housing interior, said housing adapted to support at least one battery in a received state;
(B) a top cover enclosing the interior opposite said base, said top cover being formed of a light transmissive material;
(D) a light source disposed in the interior of said housing in electrical communication with said battery by means of an electrical switch arrangement including at least a pair of prong-like first and second electrical contacts in electrical communication with said battery when in the received stated, said first and second electrical contacts protruding through said base on a first side thereof and adapted to penetrate the support surface when said base is placed in confronting relation thereto;
(E) a light source disposed in the interior of said housing in electrical communication with said battery by means of an electrical switch arrangement including at least a pair of prong-like electrical contacts protruding through said base so as to extend exteriorly of said housing, such that, when electrical current flows between said first and second contacts, said light source is operative to produce light; and
(F) a light reflector dish associated with said light source.

12. An illumination device according to claim 11 wherein said reflector dish is concave with said light source being located along the axis thereof, said reflector dish having a radius of curvature operative to spread light emitting from said light source.

13. An illumination device according to claim 12 wherein said light source is mounted on a printed circuit board, said housing including at least one upright stanchion, said printed circuit board being supported on said stanchion.

14. An illumination device according to claim 13 wherein said reflector dish included a central opening therein that is oriented so that said light source projects through the opening, said printed circuit board is sandwiched between said stauchion and said reflector dish.

15. An illumination device according to claim 11 wherein said reflector dish is mounted to said top cover, said top cover being removably secured to said housing.

16. An illumination device according to claim 11 wherein said base includes a plurality of legs on the first side thereof, said legs projecting away from said base a distance greater than the protrusion of said electrical contacts.

17. An illumination device according to claim 11 wherein said power source includes at least one battery, said base including at least one bay adapted to receive said battery.

18. An illumination device according to claim 17 wherein said bay opens exteriorly of said housing.

19. An illumination device according to claim 11 wherein said top cover includes a plurality of facets configured in a prism-like fashion so as to disperse light from said light source.

20. An illumination device according to claim 11 wherein said housing has a width dimension greater than its height dimenso.

21. An illumination device according to claim 21 wherein said housilng is generally cylindrical in configuration.
